(19) United States
(12) Patent Application Publication
(10) Pub. No.: US 2017/0251297 A1
(43) Pub. Date: Aug. 31, 2017

(54) In-Ear Earphone

(71) Applicant: SOUNDCHIP SA, Aran-Villette (CH)

(72) Inventor: Paul Darlington, Aran-Villette (CH)

(21) Appl. No.: 15/435,424

(22) Filed: Feb. 17, 2017

(30) Foreign Application Priority Data
Feb. 17, 2016 (GB) 1602781.5

(51) Int. Cl. H04R 1/28; G10K 11/178; H04R 1/10

(52) U.S. Cl. CPC H04R 1/2853; H04R 1/1016; G10K 11/1782; H04R 1/1083; G10K 2210/1081; H04R 2460/01

(57) ABSTRACT

An in-ear earphone includes a body configured to be placed at the entrance to or to be inserted at least in part into the auditory canal of a user's ear, the body housing an electro-acoustic driver and defining a passageway structure extending from the electro-acoustic driver to an opening in an outer surface of the body for allowing sound generated by the electro-acoustic driver to pass into the auditory canal of the user's ear. The passageway structure includes a flow divider section positioned to receive forward-radiated sound from the electro-acoustic driver, an output passageway extending from the flow divider section to the opening in the body, and an unvented enclosure in fluid communication with the flow divider section and operative to provide an acoustic impedance in parallel to the output passageway.

This application claims the benefit of GB 1602781.5, filed on Feb. 17, 2016, which is hereby incorporated by reference in its entirety.

### FIELD

The present disclosure relates to in-ear earphone apparatus and particularly but not exclusively to in-ear earphone apparatus including a feedback microphone.

### BACKGROUND

In-ear earphones in the form of earbuds configured to be placed at the entrance to the auditory canal of a user's ear and “in-the-canal” devices configured to be placed in the auditory canal of a user's ear are well known electro-acoustic systems for the delivery of sound to a user. In-ear earphones incorporate at least one electro-acoustic transducer (i.e. driver) acting as a miniature loudspeaker. With reference to the legacy of the nomenclature developed in telephone engineering, the miniature loudspeakers provided in earphones are referred to as “receivers”.

Active electronic means have been incorporated into in-ear earphone systems, furnishing them with the capability to cancel (at least some useful portion of) unwanted external sound and/or to cancel excess pressures generated in the blocked (or “occluded”) ear canal during speech. This latter phenomenon, called “the occlusion effect”, makes it uncomfortable to speak whilst wearing certain earphone types. Active reduction of the occlusion effect is seen as a desirable feature of earphones used in telephony and other voice applications.

To provide active control of noise or occlusion, and to add other advanced functionality, it is useful to add additional sensors to the earphone. Microphones configured to be sensitive to either or both of the pressures inside the occluded ear canal or outside the head are warranted.

FIG. 1 illustrates a typical prior art in-ear earphone 1 comprising an electro-acoustic driver or “receiver” 2 which transduces an electrical signal into the acoustic signal sensible to the wearer. The receiver 2 may be implemented in any of several known technologies, including electrodynamic types and electrostatic types.

Both these receiver technologies have produced examples in the existing art of earphone design and manufacture wherein the acoustic source impedance of the receiver 2 is large in comparison to the load which it is to drive—in this case the human ear. Such tendency for the source impedance of a receiver to be problematically high has been observed and independently reported with reference to dynamic, Balanced Armature (BA) and piezo (i.e. “crystal”) receiver types.

In prior art in-ear earphone 1 acoustic radiation is conveyed from receiver 2 through an output passageway or waveguide 3 toward the wearer's ear. The waveguide 3 is formed within a tip or “grommet” 4 the purpose of which is to engage mechanically and acoustically with the wearer's ear in such a way as to form an acoustic seal. The body of the prior art earphone of FIG. 1 will also introduce a volume of air 5 between the waveguide 3 and the receiver 2 although this body of air is generally minimised in volume in order to minimise the overall physical size of the instrument and for other considerations.

FIG. 2 shows the same prior art earphone 1 deployed in several sealing configurations experienced in ordinary use. In FIG. 2a, the earphone 1 is correctly positioned in the external meatus 10 of the wearer, where it can function correctly. If, however, it is subjected to movement—which happens as an ordinary consequence of use—improper fit can result, leading to the appearance of a leak, such as shown in FIG. 2b at 11. An earphone with high acoustic source impedance is—by definition—leak sensitive. The response of the earphone will be materially influenced by the presence of the leak (as in FIG. 2b), as compared to the performance in the normative state (FIG. 2a), generally resulting in reduced low-frequency sensitivity.

If the position of the earphone is further displaced, such that the tip becomes blocked (as can happen during insertion) the response is even further changed from the normative loading of FIG. 2a. This case is illustrated in FIG. 2c, where the displacement of the earphone 1 is resulting in the block, 12. Finally, when the earphone is removed from the ear and subject to “free-air” loading, as illustrated in FIG. 2d, a further extreme loading condition is experienced. These two extrema (blocked and free conditions) are of particular acoustic significance and represent particularly important cases in the context of the application of active control, as is further discussed below.

The general model of a source with high source impedance can be illustrated with reference to electrical network analogies, such as that shown in FIG. 3, in which the earphone is replaced by a simplified Thévenin analogy 20 consisting of a pressure source, 21 and source impedance 22. It is the (absolute) value of this impedance relative to the load 23 into which the source is to operate which determines if the source is a high- or low-impedance source. In the electrical case, high source impedance makes the source behave as a current source, whereas low source impedance makes the source behave as a voltage source.

In the acoustical case, such as the prior-art earphones, high source impedance makes the sources behave as constant velocity sources. This, in turn, makes the pressure they develop proportional to the acoustic load. Lower source impedance would tend toward a pressure source, which has the attractive property of generating pressure independent of acoustic load.

FIG. 4 illustrates a prior art solution in the form of an in-ear earphone 32 incorporating a controlled leak 33 from the air otherwise sealed within the earphone system to the free air around the wearer. The radiation impedance presented at this point is so low as to make the pressure at the exhaust side of this leak approximately zero; the exit point is effectively at acoustic ground. Although illustrated in the form of an earphone, this strategy of introducing engineered leaks into the front volume has precedent both in the context earphone and headphone applications (see for example WO2008099137A1, U.S. Pat. No. 8,571,228 B2, U.S. Pat. No. 8,682,001 B2).

As illustrated in FIG. 5 the incorporation of controlled leak 33 acts as a shunting impedance 31 and operates to reduce the source impedance of the earphone system. This additional impedance has other consequences, as it loads the pressure source in “open circuit” conditions. But these consequences can be understood and an engineering compromise sought between the benefits of the introduction of the new impedance on the management of the network's ability to match to the load and any negative effects.

In prior art associated with circumaural/supra-aural headphones, the acoustic source impedance of the receiver and the acoustic impedance of the system between the receiver and the ear are both likely to be lower than in the case of an in-ear earphone (not least because of the larger dimensions of a circumaural/supra-aural headphone).

Accordingly, the introduction of a controlled leak is a feasible strategy in that application. In the case of an in-ear earphone, operating at higher impedance, a leak to ambient pressure may have damaging consequences to operation of the system and will only be possible through a leak itself having high impedance. This limits the usefulness of the prior art method in earphone applications to controlling blocked loading conditions (U.S. Pat. No. 8,682,001 B2).

In all cases where a leak to ambient is provided in either an in-ear earphone or a circumaural/supra-aural headphone, the leak represents a transmission path for environmental noise to enter the ear. This path reduces the passive attenuation (noise reduction) that the device affords in noisy conditions. The leak is, therefore, undesirable in ear-mounted systems for which noise attenuation is a primary function. Some practitioners have identified this weakness and coupled the deliberate introduction of a leak to the provision of an acoustic network outside the leak, which mitigates this problem to some degree (U.S. Pat. No. 8,571,228 B2).

### SUMMARY AND DESCRIPTION

In accordance with one aspect, an in-ear earphone includes a body configured to be placed at the entrance to or to be inserted at least in part into the auditory canal of a user's ear, the body housing an electro-acoustic driver and defining a passageway structure extending from the electro-acoustic driver to an opening in an outer surface of the body for allowing sound generated by the electro-acoustic driver to pass into the auditory canal of the user's ear; characterised in that the passageway structure includes: a flow divider section positioned to receive forward-radiated sound from the electro-acoustic driver; an output passageway extending from the flow divider section to the opening in the body; and an unvented enclosure in fluid communication with the flow divider section and operative to provide an acoustic impedance in parallel to the output passageway.

In this way, an in-ear earphone is provided in which an additional acoustic impedance is presented in parallel to the output passageway thereby modifying the interaction between the electro-acoustic driver and its load so as to reduce the acoustic source impedance of the earphone system. Advantageously, this reduction in acoustic source impedance may act to reduce the sensitivity of the earphone to disturbances in operation caused during abnormal loading conditions of fit, including blockage, leakage and operation into anthropometrically unusual ears. The modification is of particular relevance when active control technologies are to be deployed in the earphone, when the disturbances in operation of the earphone would further be impressed upon the operation of the control system, with potentially compounding consequences.

In one embodiment, the unvented enclosure is a transducerless unvented enclosure (e.g. with no sensing microphone/further electroacoustic driver mounted therein).

In one embodiment, the unvented enclosure presents an air-filled volume having a value of acoustic compliance greater than 0.1× the expected acoustic compliance of the auditory canal of the user's ear.

In one embodiment, the unvented enclosure presents an air-filled volume having a value of acoustic compliance greater than 0.2× the expected acoustic compliance of the auditory canal of the user's ear (e.g. greater than 0.5× the expected acoustic compliance of the auditory canal of the user's ear).

Typically a simple engineering model of the average user's auditory canal (as expressed, for example, in the IEC 711 occluded ear simulator) will present a value of acoustic compliance in the range of 1×10⁻¹¹ to 1.5×10⁻¹¹ m⁴s²kg⁻¹. Accordingly, the unvented enclosure may present an air-filled volume having a value of acoustic compliance greater than 1×10⁻¹² m⁴s²kg⁻¹ (e.g. greater than 2×10⁻¹² m⁴s²kg⁻¹, e.g. greater than 5×10⁻¹² m⁴s²kg⁻¹, e.g. greater than 1×10⁻¹¹ m⁴s²kg⁻¹).

In one embodiment, the unvented enclosure has an air-filled volume greater than 0.2 ml (e.g. greater than 0.5 ml, greater than 1 ml, greater than 1.5 ml, greater than 2 ml, greater than 3 ml or greater than 4 ml).

In one embodiment, the unvented enclosure presents a mean acoustic impedance (e.g. nominal acoustic impedance) to the electro-acoustic driver that is less than or equal to twice the mean acoustic impedance (e.g. nominal acoustic impedance) of the output passageway and the external load (e.g. less than or equal to 1.5× the mean (e.g. nominal) acoustic impedance of the output passageway and the external load, e.g. less than or equal to 1× the mean (e.g. nominal) acoustic impedance of the output passageway and the external load). The mean acoustic impedance may be a linear mean measured over a frequency range of 20 Hz-20 KHz.

In one embodiment, the flow divider section includes a bifurcated passageway section.

In a first arrangement, the unvented enclosure includes an elongate acoustic waveguide (i.e. an air-filled passageway configured to support pressure difference along its length in the propagation of an acoustic wave). In one embodiment, the elongate acoustic waveguide includes at least one folded (e.g. curved) portion. Advantageously the inclusion of a folded portion (or folded portions) may further contribute to the apparent damping of acoustic modes in the waveguide.

In a second arrangement, the unvented enclosure includes a chamber configured to provide a lumped compliance. In one embodiment, the chamber is connected to the flow divider section by a further passageway.

In one embodiment, the unvented enclosure includes a resonance suppression element (e.g. damping structure for suppressing high frequency resonance).

In one embodiment the unvented enclosure (e.g. waveguide or chamber) is configured to have dimensions and/or a degree of damping engineered so that intentional residual resonant or anti-resonant effects in acoustic impedance can be used to mitigate problems in free-air or blocked stability.

In one embodiment, the resonance suppression element is configured to realise or approximate an anechoic waveguide.

In one embodiment, the resonance suppression element includes conventional distributed damping structure (e.g. foams and/or gauzes).

In one embodiment, the resonance suppression element includes a structure for low-order mode fragmentation such as a honeycomb structure or similar discrete obstruction.

In one embodiment, the resonance suppression element includes distributed damping structure such as vanes parallel to the acoustic velocity causing loss through boundary effect.

In one embodiment, the in-ear earphone further includes a sensing microphone coupled to the body for providing a feedback signal to a signal processor, the sensing microphone including a sensing element positioned to sense pressure changes in the auditory canal of the user's ear to provide a feedback signal to a signal processor (e.g. Active Noise Reduction (ANR) processor to allow for removal of occlusion noise). In one embodiment, the sensing microphone is located outside of the unvented enclosure (e.g. in the output passageway or in a further passageway connected to the unvented enclosure via the output passageway). In this way, the reduction of acoustic source impedance achieved by the unvented enclosure may further act to increase the stability margin of the feedback control system. For example, the resulting earphone system may be more robust to the specific changes in internal pressures experienced when the in-ear earphone becomes “blocked” during insertion, manipulation or otherwise thereby increasing the potential overall practical stability margin of the feedback control system.

In one embodiment, the body includes a longitudinal axis associated with an insertion direction of the in-ear earphone.

In one embodiment, the opening is defined by a tip (e.g. grommet) portion of the body configured to seal the user's auditory canal (e.g. when the body is inserted at least in part into the user's ear).

In one embodiment, the drive axis of the electro-acoustic driver is inclined relative to the longitudinal axis of the body

In one embodiment, the drive axis is substantially perpendicular to the longitudinal axis of the body.

In one embodiment, the output passageway extends substantially parallel to the longitudinal axis of the body.

In one embodiment, at least a portion of the acoustic waveguide or further passageway extends substantially perpendicular to or in an opposed (e.g. substantially opposed) direction to the insertion direction.

In one embodiment, the unvented enclosure has an entrance in the flow divider section.

In one embodiment, the entrance to the unvented enclosure is substantially opposed to an entrance to the output passage.

In one embodiment, the entrance to the unvented enclosure is positioned substantially perpendicular to an entrance to the output passageway.

In one embodiment, the entrance to the unvented enclosure and the electro-acoustic driver are substantially equidistant from the opening in the body.

In one embodiment, the unvented enclosure is longitudinally spaced from the output passageway by the flow divider section and/or electro-acoustic driver.

In one embodiment, the unvented enclosure is laterally spaced from the output passageway relative to the longitudinal axis of the body.

In one embodiment, the electro-acoustic driver and unvented enclosure are located on opposed sides of the longitudinal axis of the body.

In one embodiment, the waveguide is at least in part defined by a protuberant element of the body (e.g. elongate protuberant element) extending from a main body portion housing the electro-acoustic driver, the protuberant element being configured to assist location of the in-ear earphone in a user's ear. In one embodiment, the protuberant element is movable relative to the main body portion between an insertion position and an installed position in which a part of the protuberant element engages with a part of the user's ear (e.g. anti-helix or helix of the user's pinna). In one embodiment, the protuberant element is biased in the installed position.

### BRIEF DESCRIPTION OF THE DRAWINGS

FIG. 1 is a schematic illustration of a prior art in-ear earphone device.

FIGS. 2A-2D are schematic illustrations of the prior art in-ear earphone device of FIG. 1 in a variety of sealing conditions.

FIG. 3 is an illustration of an electrical network equivalent to the prior art in-ear earphone device of FIG. 1.

FIG. 4 is a schematic illustration of a second prior art in-ear earphone device with a controlled leak to ambient.

FIG. 5 is an illustration of an electrical network including a shunting impedance equivalent to controlled leak of the in-ear earphone device of FIG. 4.

FIG. 6 is a schematic illustration of an in-ear earphone device in accordance with a first embodiment.

FIG. 7 is a schematic illustration of the in-ear earphone device of FIG. 6 when in use.

FIGS. 8A-8D are schematic illustrations comparing the electrical network equivalent of the in-ear earphone device of FIG. 6 with that of the prior art in-ear earphone of FIG. 1.

FIGS. 9A and 9B are illustrations of an electrical network equivalent to the prior art in-ear earphone device of FIG. 4.

FIGS. 10A-10D are schematic illustrations comparing the electrical network equivalent of the in-ear earphone device of FIG. 6 with that of the prior art in-ear earphone of FIG. 4.

FIG. 11 is a schematic illustration of in-ear earphones in accordance with further embodiments.

FIG. 12 is a schematic illustration of in-ear earphones in accordance with yet further embodiments together with an electrical network equivalent.

FIGS. 13-16 are schematic illustrations comparing the electrical network equivalent of the in-ear earphone device of FIG. 6 with that of the prior art in-ear earphone of FIG. 1 in a variety of sealing configurations.

FIGS. 17-22 are graphs illustrating expected impedance/response values for the sealing configurations shown in FIGS. 13-16.

FIG. 23 is a schematic illustration of an in-ear earphone in accordance with another embodiment in uninstalled and installed positions.

FIG. 24 is a schematic illustration of an in-ear earphone in accordance with yet another embodiment in uninstalled and installed positions.

FIG. 25 is a table of equations describing the behaviour of the in-ear earphone device of FIG. 6 and for comparison the equations describing the behaviour of the prior art in-ear earphone device of FIG. 1.

### DETAILED DESCRIPTION

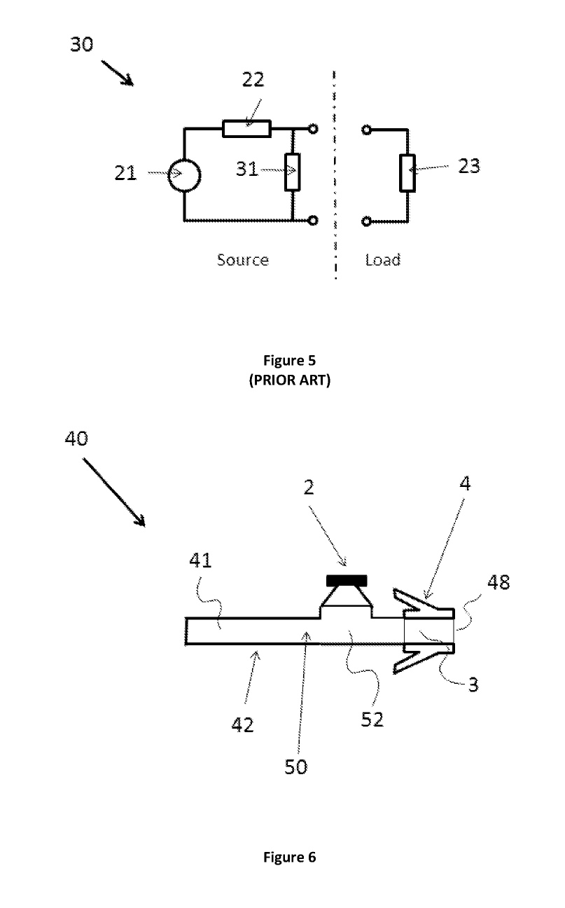

FIG. 6 shows an in-ear earphone 40 including a body 42 including a flexible tip or grommet 4 configured to be inserted at least in part into the auditory canal of a user's ear, the body 42 housing an electro-acoustic driver 2 and defining a passageway structure 50 extending from the electro-acoustic driver 2 to an opening 48 in an outer surface of grommet 4 for allowing sound generated by the electro-acoustic driver 2 to pass into the auditory canal of the user's ear. As illustrated, passageway structure 50 includes: a flow divider section 52 positioned to receive forward-radiated sound from the electro-acoustic driver 2; an output passageway 3 extending from the flow divider section 52 to the opening 48 in the grommet 4; and an unvented enclosure 41 in fluid communication with the flow divider section 52 and operative to provide an acoustic impedance in parallel to the output passageway 3.

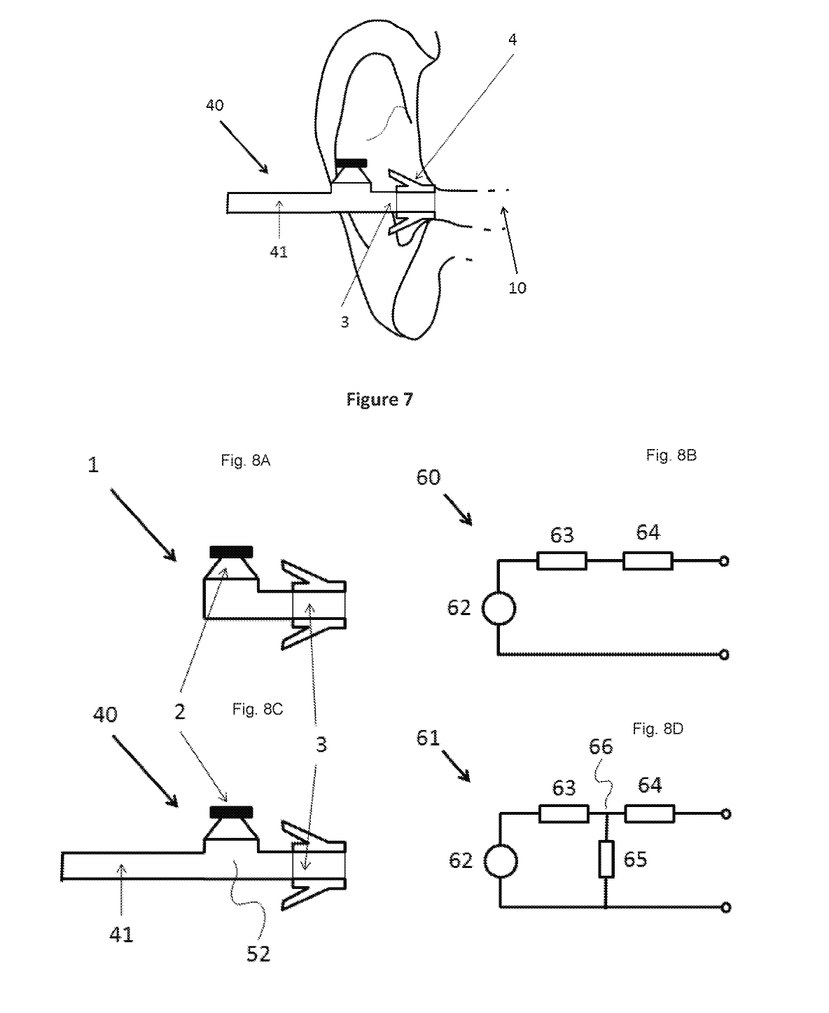

In use, as seen in FIG. 7, once the tip 4 of the new earphone 40 achieves seal to the wearer's ear, the air in the additional volume of air in the unvented enclosure 41 is contiguous with the air in the output passageway 3 and the air in the external meatus 10. The air in these three spaces, 41, 3 & 10, is connected to form one coupled volume at low frequency and one coupled acoustic network at higher frequencies.

However, as is expressed diagrammatically in FIG. 7, the additional unvented enclosure 41 is usually distally located with respect to the receiver. This location is dictated pragmatically, by the space available around the wearer's ear. Sound from the receiver travels inward toward the ear canal—but the sound travels outward or, at best, laterally, to enter the unvented enclosure 41.

The consequences of the introduction of the unvented enclosure 41 are introduced by comparison of a simple analogous circuit of the new teaching with the prior art earphone. This is described in connection with FIGS. 8a-8d. The prior art earphone 1 of FIG. 8a has an equivalent representation 60 as shown in FIG. 8b, in which the receiver's open-circuit pressure 62 and source impedance 63 couple to the load through the acoustic impedance of the air in the tip 64. The modified earphone of the new teaching 40 seen in FIG. 8c, has an equivalent representation 61 as shown in FIG. 8d. This analogous circuit representation shares the elements which are parameters of the receiver (62 & 63) and the tip (64) as these components are common to both earphone designs 1 and 40. However, the additional enclosed volume 41 is represented by a shunting acoustic impedance, seen in FIG. 8d as the impedance 65. The function of this impedance (c.f. 31 of FIG. 4) shall be to adjust the characteristics of the entire earphone, including by reducing its acoustic source impedance, so as to confer favourable operational characteristics described further below. Air is directed into this impedance by the action of the flow divider section 52, which is represented in the analogous circuit by the circuit node 66.

The introduction of the unvented enclosure 41 communicating with the enclosed volume of air in the canal of the user of an earphone will address at least the following intended benefits:

Improved fit tolerance—the earphone will deliver performance closer to the intended frequency response over a greater range of fit/seal conditions, due to the reduced source impedance.

Improved Wearer-to-wearer consistency—the earphone will deliver greater consistency between wearers having different outer ear geometries, due to the reduced source impedance.

Improved passive attenuation—the earphone will deliver higher levels of passive attenuation, due to the increased acoustic compliance of the volume of air protected around the eardrum.

Improved Stability—in the context of the application of active control measures to the earphone, the reduced load sensitivity conferred by the reduction of the acoustic source impedance of the earphone will result in an increase in stability margin of the control system

These significant benefits are won at the expense of only one significant disadvantage—the provision of space to accommodate the additional physical volume. It is intended that this space be provided within the main body of the instrument and/or within protrusions from that body intended to assist in locating the instrument within the ear. As the typical enclosed volume of the (occluded) ear is of order 2 ml, this volume will not be difficult to accommodate in an instrument intended to occupy the concha, which has typical volume of 4 ml. The unvented enclosure (or the instrument itself) may extend outside the concha.

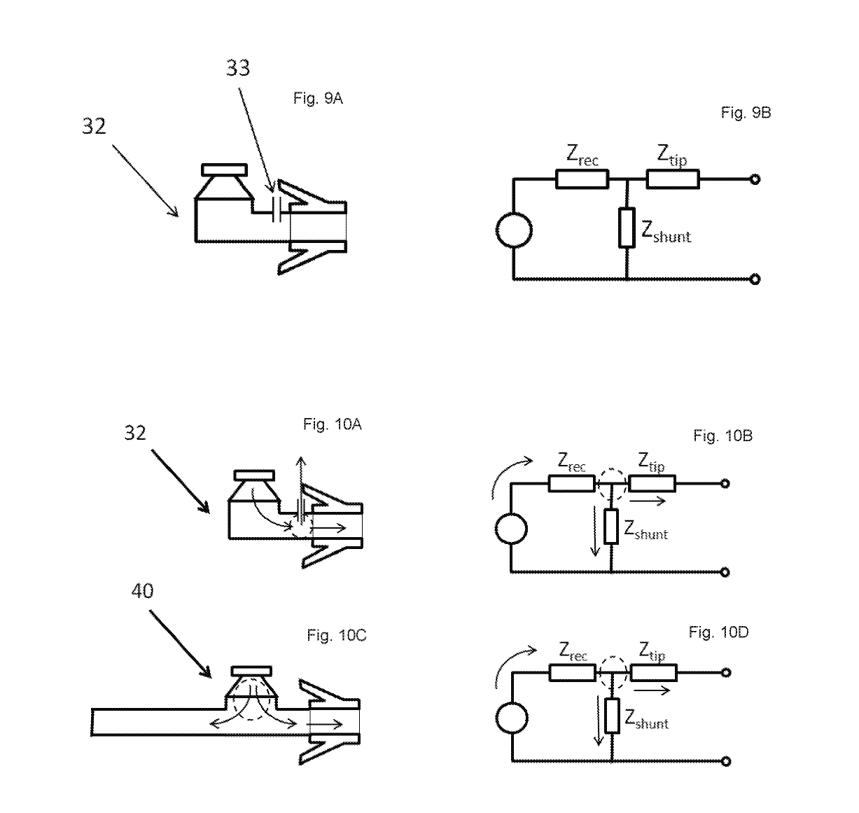

Although the physical configuration of the new earphone 40 is very different from the prior art earphone with intentional leak 32 their simple analogous circuits (see FIGS. 8d and 9b) share certain similarities arising from the split in the volume velocity output of the receiver into two components, one of which “enters” the ear and the other of which “enters” the shunting impedance. This split is illustrated in FIGS. 10, in which the volume velocity radiated from the receiver of the prior art earphone is seen to split between the ear and the leak, as illustrated by the arrows in FIG. 10a. The same split occurs at the node in the equivalent circuit, sending some of the “velocity” (modelled in the analogous circuit as a current) through the leak impedance and the remainder through the load (the ear), as seen in FIG. 10b. An equivalent velocity split occurs in the earphone constructed according to the new teaching, a shown in FIG. 10c, where the volume velocity output of the receiver into two components, one of which “enters” the ear and the other of which “enters” the unvented enclosure. Note that the change of “direction” of the velocity at the split point in FIG. 10c, associated with entry to the distally-located shunt volume, is of no consequence to the equivalent network of FIG. 10d.

Note further that the precise location of the leak to ambient 32 in the prior art device is immaterial (to the low orders of approximation used in the analogous circuits shown in this document and familiar in the art). All that a change of location of the leak 32 of FIG. 10a would imply is a change in the ratio of the impedances Z_{rec} and Zₜᵢₚ in FIG. 10b (and similarly for other leak locations discussed herein).

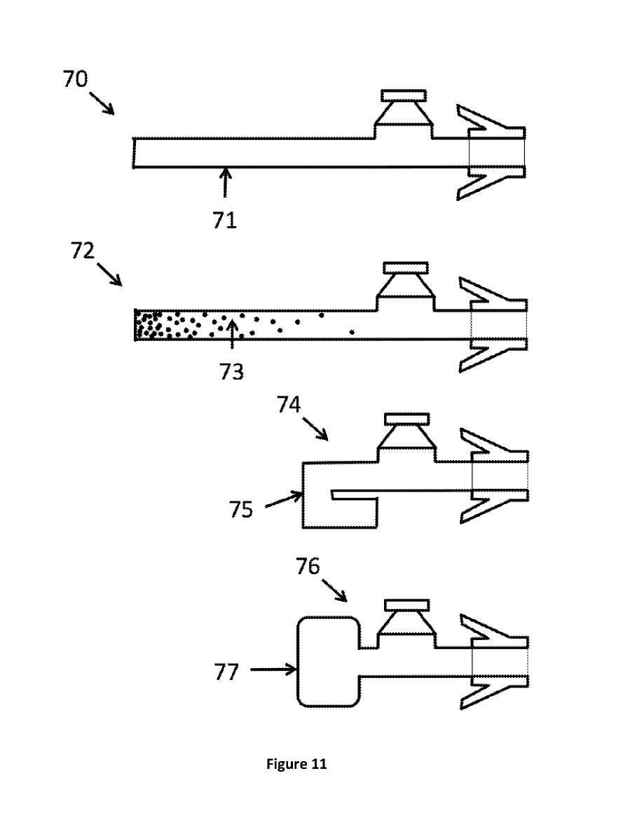

The unvented enclosure 41 may take several forms, implying both several different possible means of implementation and several different modes of acoustic operation. Some examples of these alternative implementations are illustrated in FIG. 11.

The earphone 70 includes an unvented enclosure of elongate section with a sealed distal end, 71. This acoustic waveguide element will operate properly to lower the acoustic source impedance of the earphone at low frequencies, but may exhibit acoustic resonances at higher frequencies. The earphone 72 includes a waveguide implementation of the unvented enclosure, but this is filled with a damping medium, illustrated by the material suggested by the dots 73 designed to suppress resonance. This resonance suppression element 73 makes the unvented enclosure an anechoic waveguide, which does not support resonances. The implementation of acoustic damping within the waveguide by other means familiar within acoustical engineering—such as the introduction of honeycomb lattice structures (from analogies with loudspeaker enclosure manufacture) or the provision of layered, axial fins in the waveguide (from e.g. analogies with laminar fans) provide alternative, practical implementation means for the anechoic waveguide.

It will be understood by ordinarily skilled practitioners that an anechoic waveguide may be arranged to present “characteristic” input impedance. By control of the cross sectional area of such an anechoic waveguide, the said component may be used to provide (to first degree of approximation) a resistive acoustic impedance of arbitrary magnitude. This concept will be used in an illustrative example, below.

The earphone 74 uses an unvented enclosure in the form of a waveguide (understood to be in the anechoic embodiment) but folds it at one or more points along its length, to make a folded waveguide 75. Equivalently, the number of folds can increase to the point where the waveguide is curved. The act of folding the waveguide has the desirable consequences of both making the waveguide spatially compact, allowing it to be integrated into the physical form-factor of an earphone more easily, and further adding to acoustic losses in the system. The effects of the folds tend to break up the formation of (low-order) modes in the waveguide and serve to add acoustic resistance.

The earphone 76 uses a lumped acoustic volume 77 to implement the unvented enclosure. This presents an acoustic compliance at low frequencies where it does not present the same explicit resonances as the “waveguide” implementations above—although such resonances do start to appear at higher frequencies, when the dimensions of the unvented enclosure 77 start to look significant compared to the acoustic wavelength. At these higher frequencies, the volume element may be damped (using either of the methods discussed above). Also, in the case of the application of active control, dimensions of the volume may deliberately be selected to support or attenuate unwanted resonances which may occur (e.g. during abnormal loading conditions, such as the blocked case described further below).

The acoustic compliance of the lumped acoustic volume 77 is given by a standard, well-known equation:

$$C = \frac{V}{{ρ}_{0} {c}^{2}}$$

in which C is the acoustic compliance, V is the enclosed volume, ρ₀ is the equilibrium mass density and c is the speed of sound. In addition to describing the acoustic compliance of a lumped compliance element of volume V, this equation gives a useful means to approximate the low-frequency limiting behaviour of the impedance of any unvented volume of air, having volume V.

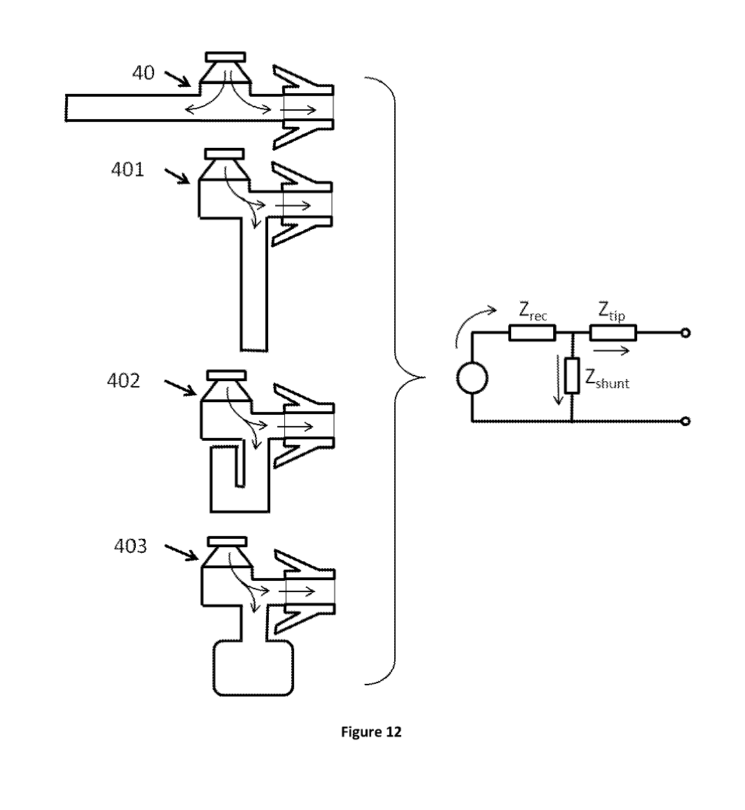

Although practical considerations of space will suggest a distal location of the unvented enclosure 41 relative to the receiver 2 this does not preclude other embodiments of the teaching herein. FIG. 12 emphasises the equivalence of the embodiment 40, in which the unvented enclosure is distally located, to cases where the unvented enclosure is disposed proximal to the ear. In 401 the unvented enclosure is arranged as a waveguide. In 402 the unvented enclosure is arranged as a folded waveguide. In 401 the unvented enclosure is arranged as a lumped compliance. In all cases 401:403, the introduction of acoustic damping, as previously described, will be advantageous. The systems of FIG. 12 share a common equivalent circuit.

Having listed similarities between prior art strategies and the new teaching disclosed herein, it is appropriate to emphasise key differentiating features of the new earphone's architecture. The unvented enclosure 41 of the new earphone is explicitly sealed from ambient acoustic conditions. This has the consequence of introducing all the advantages listed above, some of which also may be delivered—in whole or in part—by prior art strategies. However, the new teaching:

Does not introduce a transmission path for noise ingress into the earphone, thereby upholding passive noise reduction afforded by the earphone.

Retains the seal of the headphone at zero frequency, thereby retaining the high load impedance at low frequencies for the operation of certain receiver technologies important to the art of the construction of earphone and having high acoustic source impedance

We now describe the relative performance of the conventional earphone, as compared to the earphone according to the new teaching, in terms of the circuit analogies of FIGS. 8a-8d, in certain important applications.

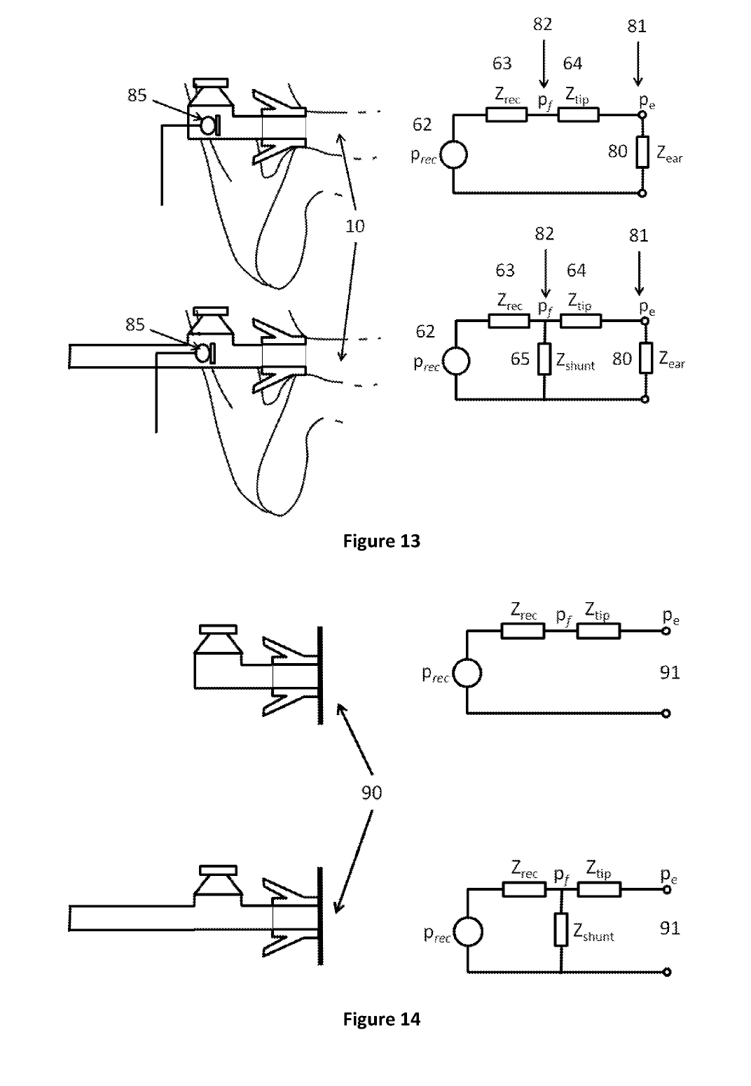

The application to Standard Fit conditions is shown in FIG. 13, in which the input impedance of the ear's external meatus 10 under correct fit conditions is represented by an acoustic impedance 80. Notation is introduced for the open-circuit pressure and source impedance of the receiver (62 & 63), the tip impedance (64), the shunting impedance of the air in the unvented enclosure (65), which will be used in analytical results presented below. These analyses will solve for the pressure in the ear 81 or for the pressure at a point inside the earphone 82 where a sensing microphone 85, used as part of an active control system, may be located.

The “blocked” condition, illustrated in FIG. 14, describes the case where the acoustic output is sealed by an impervious barrier as 90. This corresponds to the electrical open-circuit loading shown in the analogous circuits 91.

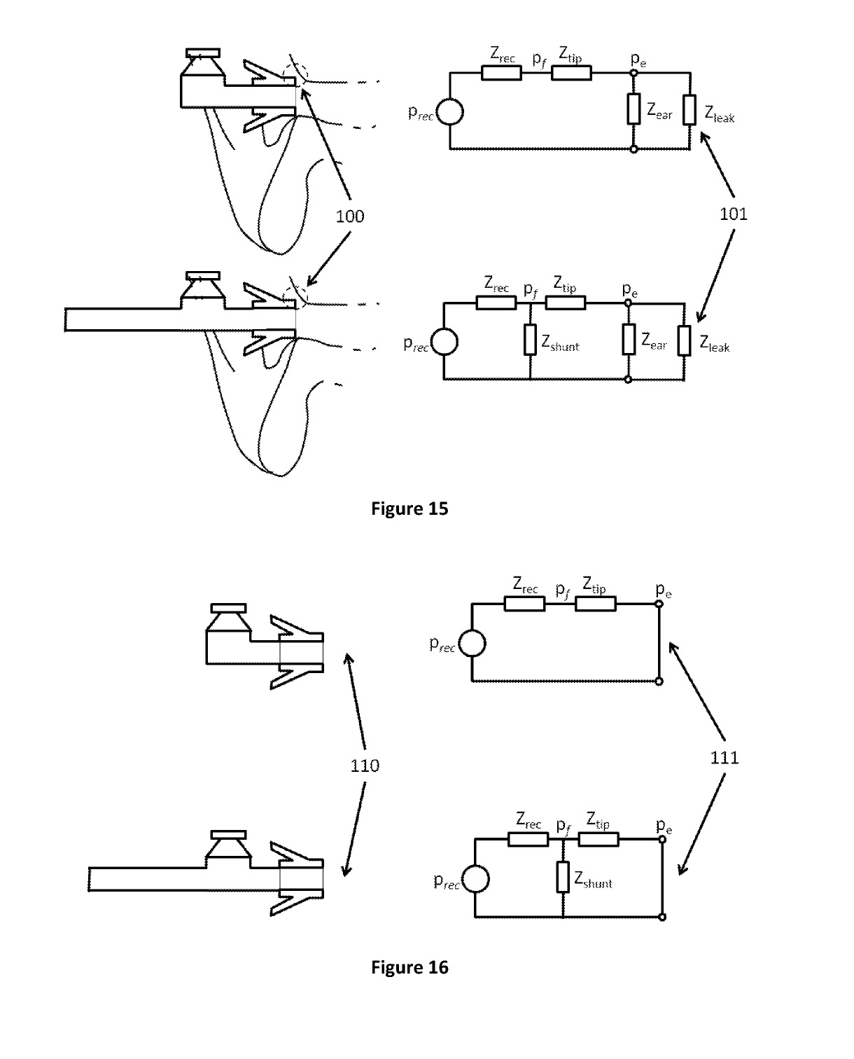

Application of earphones in the presence of a leak is compared in FIG. 15. The leak, 100, is represented by an acoustic impedance 101 which appears in parallel with the load 80.

Operation of earphones into “free-air” loading is depicted in FIG. 16. The acoustic load presented when the earphone radiates into free air 110 is very small and is usefully approximated by zero. Under this approximation, the analogous circuit has short-circuit output loading, 111.

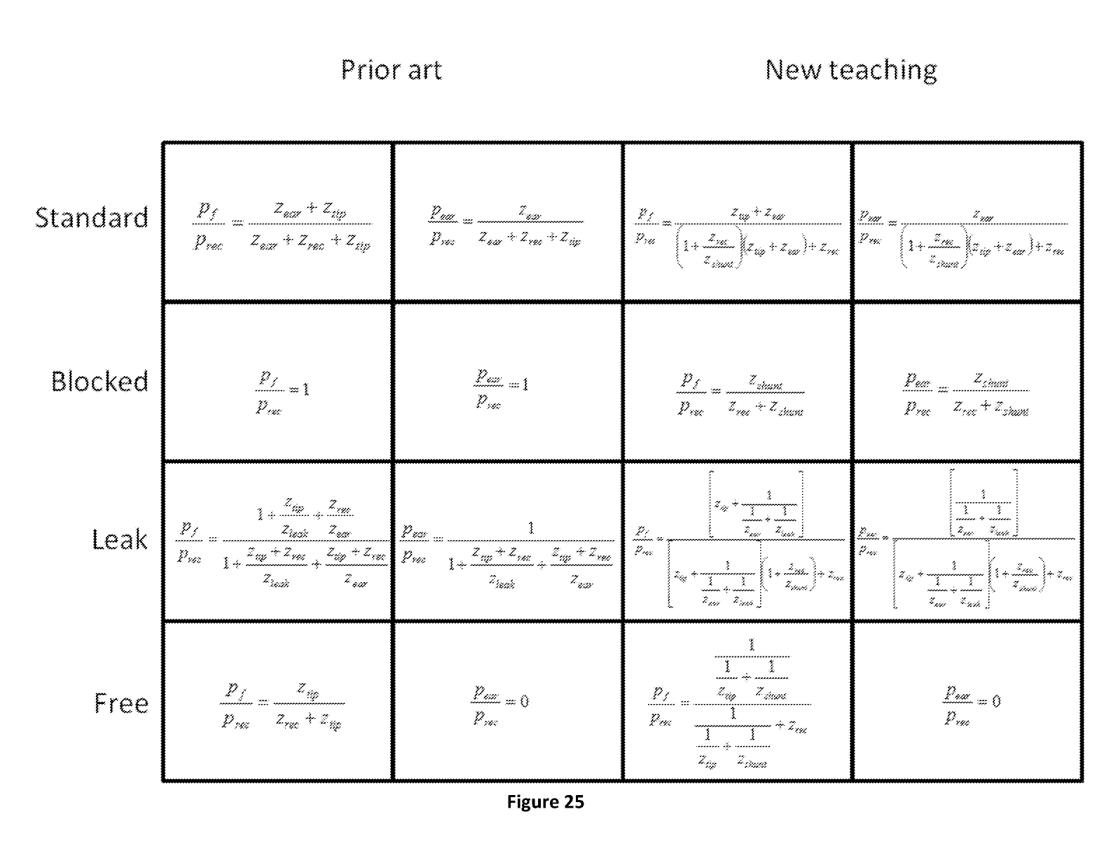

The solutions for the ratio between open-circuit pressure and the pressure at the internal reference position 82 and in the ear 81 for each of the four loading conditions described in FIGS. 13-16 is obtained by conventional circuit analysis. The results are shown in the table presented as FIG. 25.

As it is rather difficult to see the consequences of the additional impedance (Zₛₕᵤₙₜ) from the solutions in the table, an illustrative example is presented.

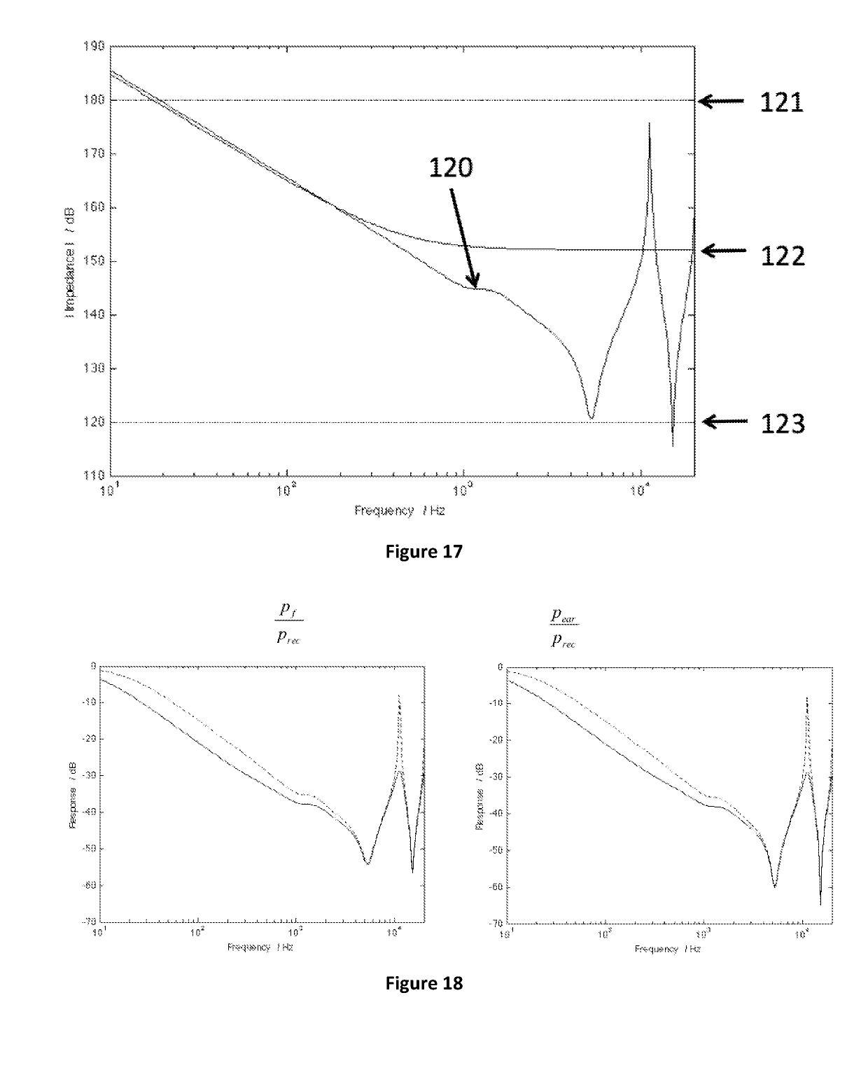

Consider an earphone, constructed according to the new teaching, firing into a load represented by the acoustic input impedance of the IEC711 ear simulator. This generates a known impedance that can be modelled using well-rehearsed approximations, resulting in the frequency-dependent trace 120, shown in FIG. 17. Also seen in FIG. 17 are three other impedances, two of which are RESISTIVE impedances (that is to say, impedances which are independent of frequency). The highest 121 shall be used in the simulations that follow to represent the acoustic source impedance 63 of a hypothetical receiver, 2. Notice that for the greater part of the frequency range of interest, the source impedance 121 exceeds the load impedance 120.

The next impedance seen in FIG. 17, 122, is used in simulation reported below to model the acoustic impedance of the air in the unvented enclosure 41. Notice that this is comprised of the impedance of a sealed volume air (1.3 cubic centimetres) and a resistance (of 4e7 acoustic Ohms). As such, it represents a useful first-order model of the acoustic impedance of any of the embodiments of the unvented enclosure 41. The shunt impedance intentionally has magnitude similar to the load impedance 120 in the operating frequency range of the device (which practically would imply that the equivalent acoustic volume of the unvented enclosure were similar to that of the ear at these frequencies).

The lowest resistive impedance seen in FIG. 17, 123, is used in simulation reported below to model the acoustic impedance of the air 64 in the tip. It has small magnitude, compared with the load impedance, to avoid pressure loss.

The impedances 121 and 123 have been chosen as resistive elements for simplicity; they preserve the key elements of function of the new teaching without risking the confusion of unnecessary detail.

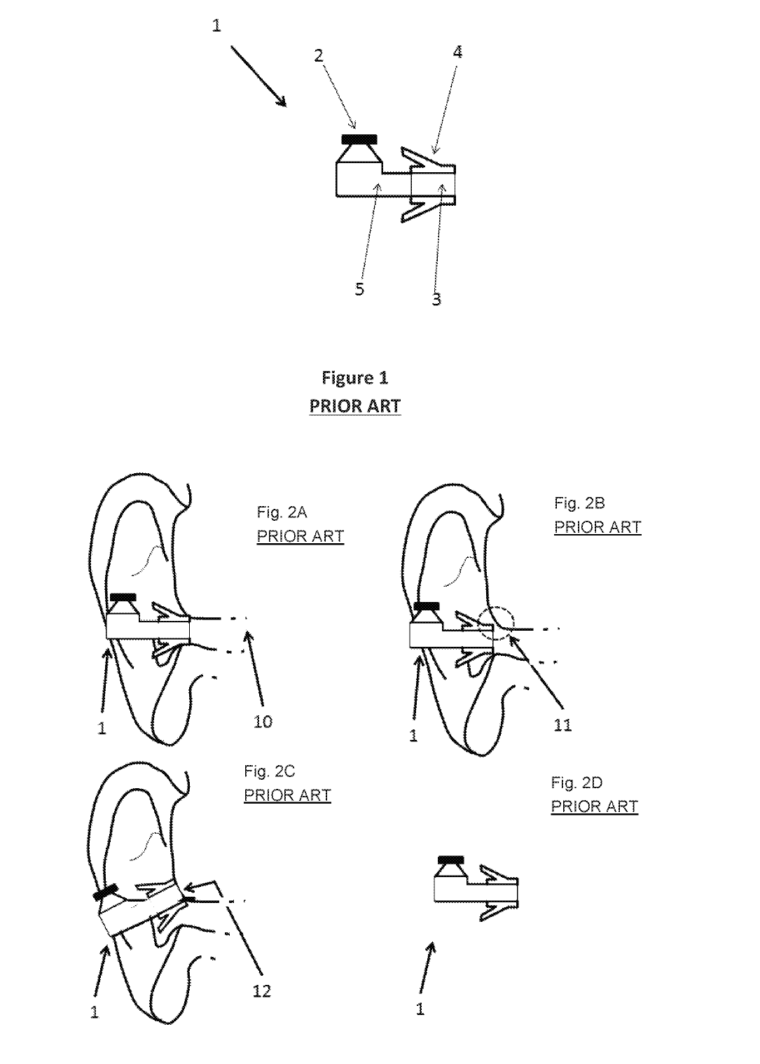

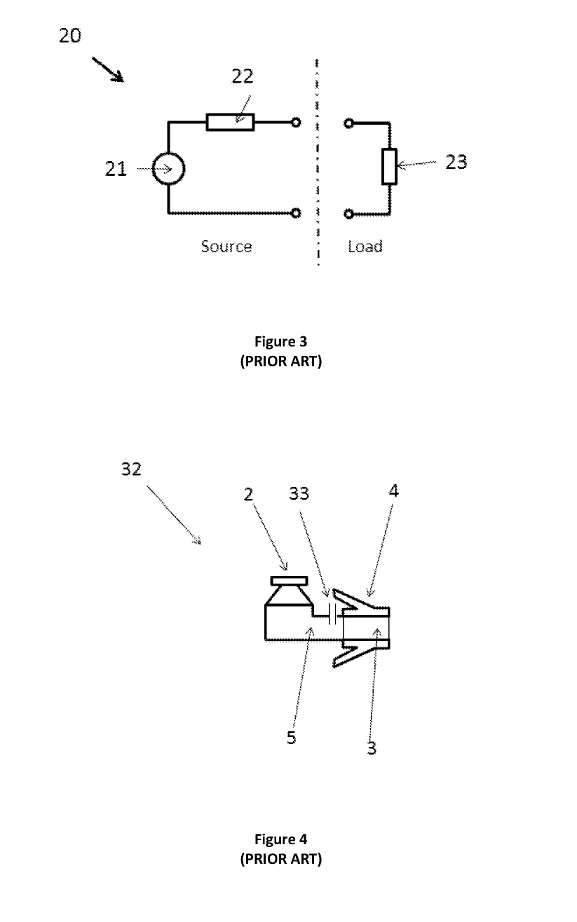

FIG. 25 shows equations describing the behaviour of the in-ear earphone device of FIG. 6 and for comparison the equations describing the behaviour of the prior art in-ear earphone device of FIG. 1

The performance of the earphone in standard fit conditions is illustrated in FIG. 18, where the prior art response is shown dashed and the new teaching response by a continuous line. The most obvious impact is the inevitable loss of low-frequency response, associated with driving a larger volume. On more careful inspection, the new earphone is able to control the very sharp 20 dB lift associated with the input impedance peak at just over 10 kHz, yielding a much smoother response.

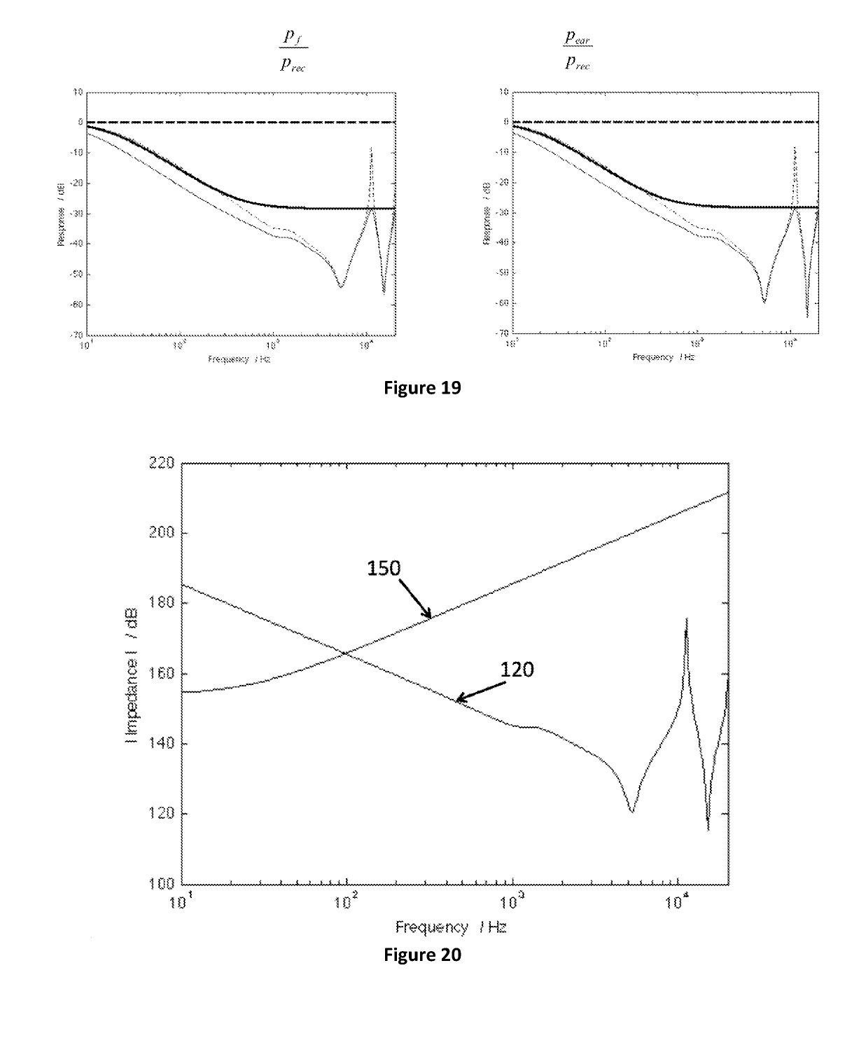

The performance of the earphone in blocked conditions is illustrated in FIG. 19, in which the standard-fit responses of FIG. 18 have been added for reference (shown by the thinner lines). The prior-art earphone's blocked response (the dashed bold lines) goes immediately up to very high magnitude, whereas the new teaching (the continuous bold lines) holds the blocked response of the modified earphone in the same pressure regime as its operation into the normal load.

To illustrate the behaviour in leak conditions a simple, representative leak impedance was established. This is shown in FIG. 20, which contrasts the magnitude input impedance of the ear 120 with that of the leak impedance 150. Notice that these are arranged to coincide at 100 Hz, to give a bass-leak typical of that experienced during earphone use.

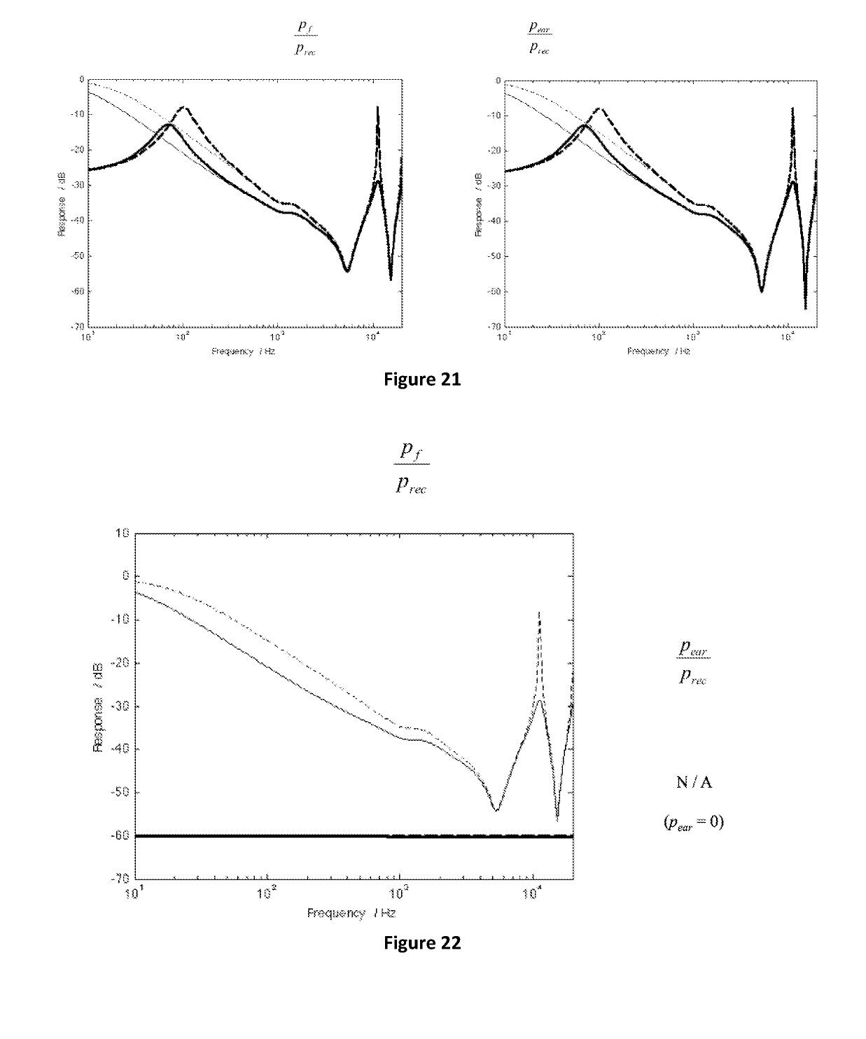

The performance of the earphone with the leak to ambient pressure defined by the impedance of FIG. 20 is illustrated in FIG. 21, in which the standard-fit responses of FIG. 18 have been added (as thinner lines) for reference. The prior-art earphone's responses (seen as dashed bold lines) are strongly influenced by the leak, but the new teaching (continuous bold lines) reduces the new earphone's leak sensitivity.

The performance of the earphone radiating into free-air is illustrated in FIG. 22, in which the standard-fit responses of FIG. 18 have been added (as thinner lines) for reference. The free-air response is of limited interest and is included for completeness.

There now are presented two detailed embodiments of the new teaching.

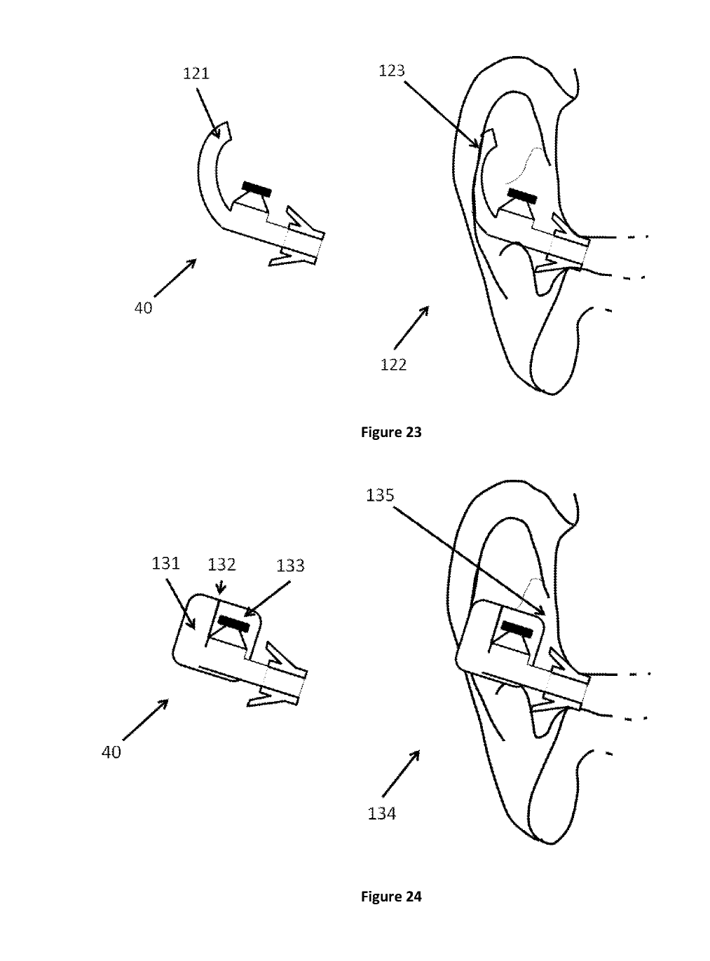

The first, shown in FIG. 23, shows the earphone 40 with the unvented enclosure 41 implemented as a folded waveguide (as taught at 75) shown as the curved form 121. This has intentionally been provided such that in use, 122, it may be physically located under the antihelix of the wearer's ear 123 thereby locating the instrument and providing a secure fit. For comfort and fit, the body of the curved waveguide 121 is formed of some material capable of elastic deformation, such that the instrument is capable of accommodating the various geometries of individual's ears. This flexibility of fit is further facilitated by the elasticity of the grommet or tip component, 4. It is understood that there will preferentially be included damping measures within the waveguide 121 such that it is implementing a folded anechoic waveguide, as taught at 73.

The second detailed embodiment is shown in FIG. 24, in which the new earphone, 40, with the unvented enclosure 41 implemented as a lumped volume element (as taught at 75) shown as the outer enclosure sealing the body of air 131. Note that internal barriers 132 partition this volume of air 131 from that which experiences the “back radiation” from the receiver 133 and which may also be associated with other ordinary functions of the body of an earphone (such as housing electronics, cable entry, acoustic venting arrangements for the rear of the receiver etc). The unvented enclosure 41 is associated only with the volume of air 131 under the entire outer body of the instrument. In use, 134, the instrument sits substantially in the concha 135 of the wearer's ear but volumetric considerations may demand that it protrudes and extends beyond the limits of the concha.

1. An in-ear earphone comprising:
a body configured to be placed at the entrance to or to be inserted at least in part into the auditory canal of a user's ear, the body housing an electro-acoustic driver and defining a passageway structure extending from the electro-acoustic driver to an opening in an outer surface of the body for allowing sound generated by the electro-acoustic driver to pass into the auditory canal of the user's ear;
wherein the passageway structure comprises:
a flow divider section positioned to receive forward-radiated sound from the electro-acoustic driver;
an output passageway extending from the flow divider section to the opening in the body; and
an unvented enclosure in fluid communication with the flow divider section and operative to provide an acoustic impedance in parallel to the output passageway.

2. An in-ear earphone according to claim 1, wherein the unvented enclosure presents an air-filled volume having a value of acoustic compliance greater than 0.1 times the expected acoustic compliance of the auditory canal of the user's ear.

3. An in-ear earphone according to claim 1, wherein the flow divider section comprises a bifurcated passageway section.

4. An in-ear earphone according to claim 1, wherein the unvented enclosure comprises an elongate acoustic waveguide.

5. An in-ear earphone according to claim 4, wherein the elongate acoustic waveguide includes at least one folded portion.

6. An in-ear earphone according to claim 1, wherein the unvented enclosure comprises a chamber configured to provide a lumped compliance.

7. An in-ear earphone according to claim 6, wherein the chamber is connected to the flow divider section by a further passageway.

8. An in-ear earphone according to claim 1, wherein the unvented enclosure comprises a resonance suppression element.

9. An in-ear earphone according to claim 1, wherein the in-ear earphone further comprises a sensing microphone coupled to the body for providing a feedback signal to a signal processor, the sensing microphone comprising a sensing element positioned to sense pressure changes in the auditory canal of the user's ear to provide a feedback signal to a signal processor.

10. An in-ear earphone according to claim 9, wherein the sensing microphone is located outside of the unvented enclosure.

11. An in-ear earphone according to claim 1, wherein the unvented enclosure is longitudinally spaced from the output passageway by the flow divider section and/or electro-acoustic driver.

12. An in-ear earphone according to claim 1, wherein the unvented enclosure is laterally spaced from the output passageway relative to the longitudinal axis of the body.

13. An in-ear earphone according to claim 12, wherein the electro-acoustic driver and unvented enclosure are located on opposed sides of the longitudinal axis of the body.

14. An in-ear earphone according to claim 1, wherein the waveguide is at least in part defined by a protuberant element of the body extending from a main body portion housing the electro-acoustic driver, the protuberant element being configured to assist location of the in-ear earphone in a user's ear.

15. An in-ear earphone according to claim 14, wherein the protuberant element is movable relative to the main body portion between an insertion position and an installed position in which a part of the protuberant element engages with a part of the user's ear.

16. An in-ear earphone according to claim 15, wherein the protuberant element is biased in the installed position.
